(19) United States
(12) Patent Application Publication
(10) Pub. No.: US 2017/0079238 A1
(43) Pub. Date: Mar. 23, 2017

(54) PET CABANA

(71) Applicant: Doskocil Manufacturing Company, Inc., Arlington, TX (US)

(72) Inventor: Jack W. RENFORTH, Azle, TX (US)

(21) Appl. No.: 15/266,262

(22) Filed: Sep. 15, 2016

Related U.S. Application Data
(60) Provisional application No. 62/220,501, filed on Sep. 18, 2015.

(51) Int. Cl. A01K 1/035; A01K 1/03

(52) U.S. Cl. CPC A01K 1/0353; A01K 1/033

(57) ABSTRACT

A pet cabana includes a base section, a wall section, a roof section, and a gathered material layer. The base section forms a bottom portion of the pet cabana. The wall section is attached to a periphery of the base section and extends upward from the base section. The roof section is attached to an upper periphery of the wall section such that the roof section is disposed above the base section when the base section rests on a horizontal surface. The base section, the wall section, and the roof section define an interior space. The gathered material layer is attached liberally to an interior surface of at least one of the wall section and the roof section such that the gathered material layer includes at least one freely hanging portion that droops from the interior surface within the interior space.

### CROSS-REFERENCE TO RELATED APPLICATIONS

This application claims priority under 35 U.S.C. §119 to Provisional U.S. Patent Application No. 62/220,501 filed on Sep. 18, 2015. The entire disclosure of Provisional U.S. Patent Application No. 62/220,501 is hereby incorporated herein by reference.

### BACKGROUND

Field of the Invention

The present invention generally relates to a pet cabana. More specifically, the present invention relates to a pet cabana provided with gathered fabric on an internal surface of the pet cabana.

Background Information

Conventional pet cabanas have been provided that form an enclosure around a pet such as a cat. A pet cabana can be used for play or rest by the pet.

### SUMMARY

Generally, the present disclosure is directed to a pet cabana for use by a pet. For example, it has been found that some pets enjoy a cave-like environment inside a pet cabana used for play and/or rest.

A gathered fabric can be provided inside a pet cabana to form a cave-like environment. The gathered fabric can droop or sag from interior wall(s) and/or ceiling of the pet cabana to shrink the visual size of the opening passing through the pet cabana. A pet may interact, e.g., claw, dig, burrow and/or slide against the sagging fabric. The pet may also merely pass through or rest in the cave-like environment at least partially defined by the sagging fabric.

### BRIEF DESCRIPTION OF THE DRAWINGS

FIG. 1 is an perspective view of a first embodiment of the pet cabana with a removable pad in a removed state;

FIG. 2 is a front elevational view of the pet cabana illustrated in FIG. 1;

FIG. 3 is a rear elevational view of the pet cabana illustrated in FIGS. 1-2;

FIG. 4 is a side elevational view of the pet cabana illustrated in FIGS. 1-3;

FIG. 5 is a bottom plan view of the pet cabana illustrated in FIGS. 1-4;

FIG. 6 is an upper perspective view of a removable pad of the pet cabana illustrated in FIG. 1;

FIG. 7 is a bottom perspective view of the removable pad illustrated in FIGS. 1 and 6;

FIG. 8 is a cross-sectional view of the pet cabana illustrated in FIGS. 1-7;

FIG. 9 is a cross-sectional view of a second embodiment of a pet cabana; and

FIG. 10A is a plan view of a gathered material layer of the pet cabana illustrated in FIGS. 1-8, and FIG. 10B is a cross-sectional view of the gathered material layer of the pet cabana illustrated in FIG. 10A

FIG. 11 is a plan view of the gathered material layer and the substrate layer of the pet cabana illustrated in FIGS. 1-8 with the gathered material layer being shown in an ungathered state.

### DETAILED DESCRIPTION OF EMBODIMENTS

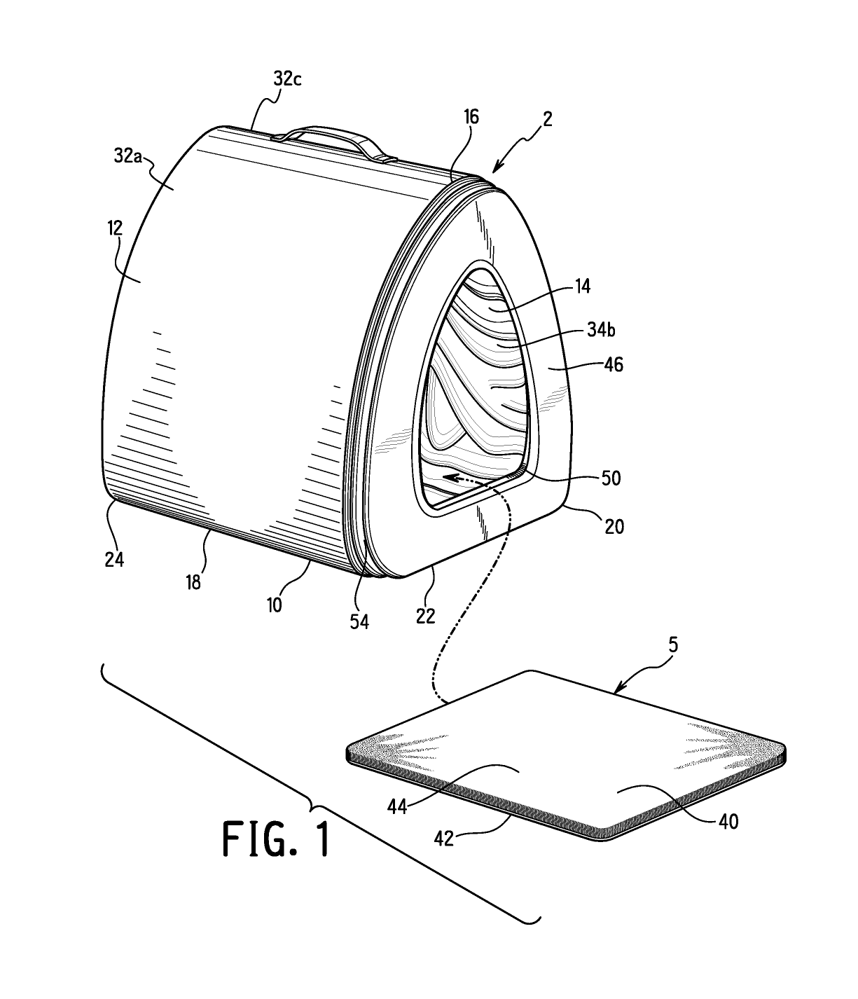

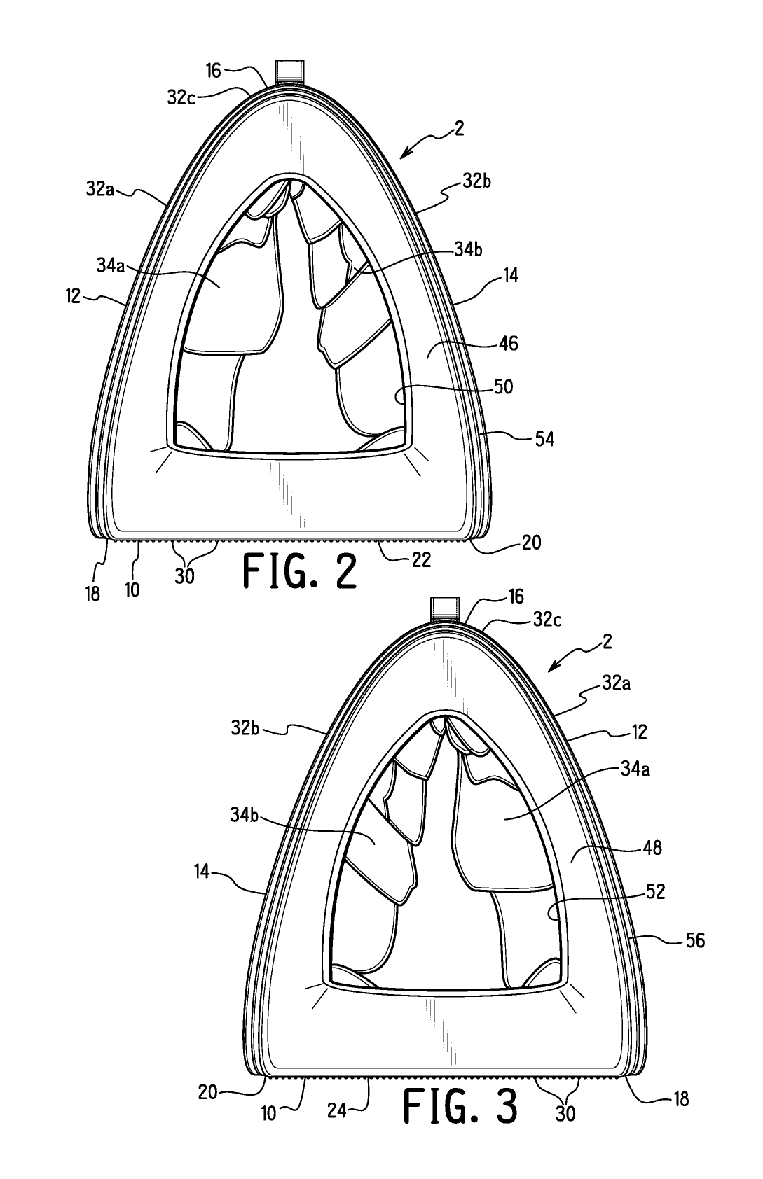

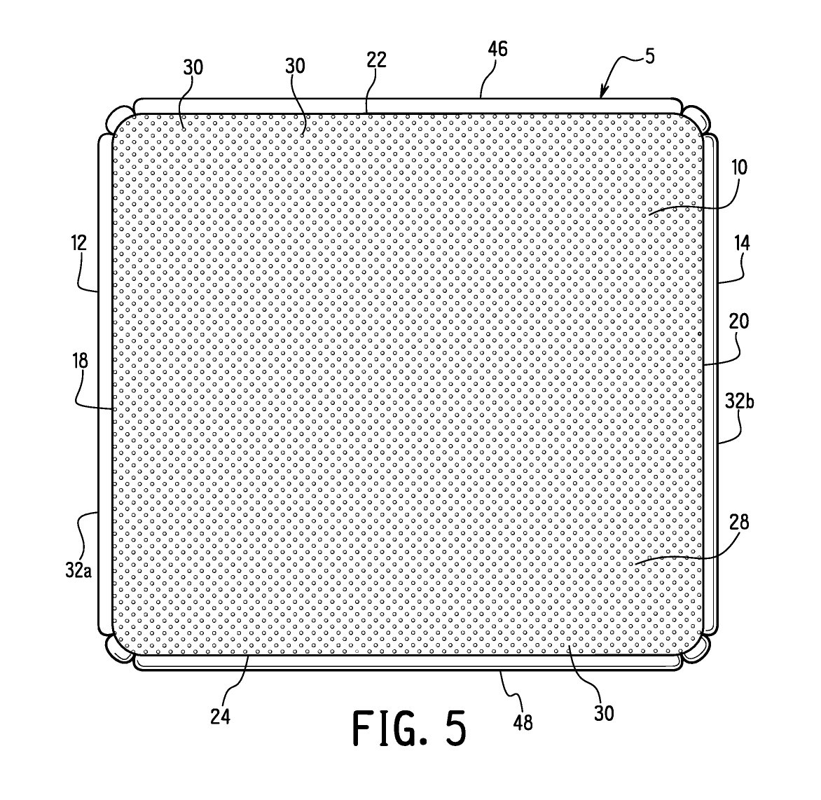

Selected embodiments will now be explained with reference to the drawings. As shown in FIGS. 1-7 the pet cabana 1 basically includes a tubular member 2 (FIGS. 1-4) and a removable pad 5 (FIGS. 5-7). The removable pad 5 is shaped to fit inside of the tubular member 2, and to rest at the bottom of the interior of the tubular member 2. As illustrated in FIG. 1, the removable pad 5 may be removed from the tubular member 2. A user may remove the removable pad 5 from the tubular member 2 for various reasons such as for the purposes of cleaning, flipping, or exchanging the removable pad 5. Of course, alternatively, the pet cabana 1 may be used without the removable pad 5.

As shown in FIGS. 1-4, the tubular member 2 basically includes a base section 10, a first wall portion 12, a second wall portion 14, and a roof section 16. Together, interior surfaces of the base section 10, the first wall portion 12, the second wall portion 14, and the roof section 16 define an interior of the pet cabana. The first wall portion 12 and the second wall portion 14 extends upwardly from opposite sides of the base section 10. The roof section 16 connects upper ends of the first wall portion 12 and the second wall portion 14 at locations spaced above the base section 10. The base section 10 has a flat rectangular shape. The first and second side portions 12 and 14 are curved with a concave interior. The roof section 16 is also curved with a concave interior. The first and second side portions of 12 and 14 are connected to the roof section 16 to form an inverted U-shape as viewed along a longitudinal axis X of the pet cabana 1, as best understood from FIGS. 1-3. In the illustrated embodiment, the interior surfaces of the first wall portion 12, second wall portion 14, and the roof section 16 are lined with the gathered material. However, it is acceptable for only one of the interior surfaces or some other portion of the interior surfaces to be lined with the gathered material.

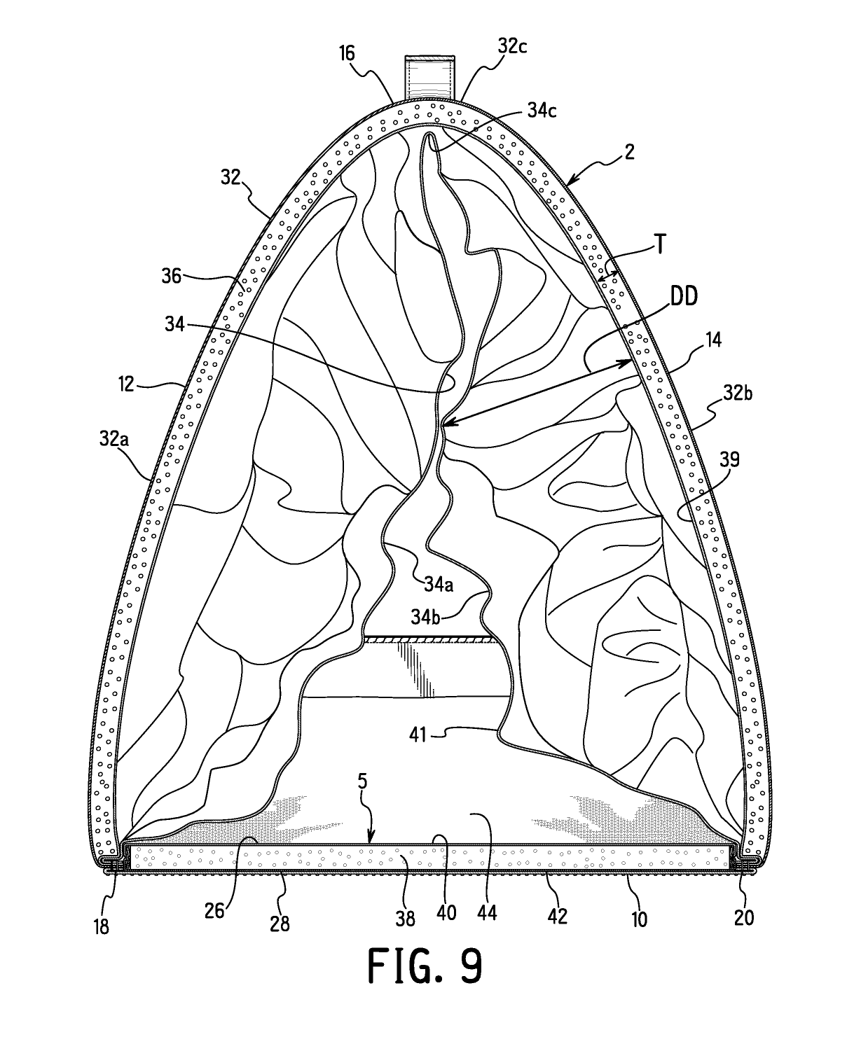

Referring now to FIGS. 5 and 8, the base section 10 of the illustrated embodiment basically comprises an external layer 28 made of a thin fabric and having a first side 18, a second side 20, a first end 22, a second end 24, an interior surface 26, and an exterior surface 28a. The first end 22 connects the first side 18 to the second side 20. Similarly, the second end 24 connects the first side 18 to the second side 20. Preferably, the length of each of the first side 18 and the second side 20 are longer than each of the first end 22 and the second end 24. The combination of the first side 18, the second side 20, the first end 22 and the second end 24 define a periphery of both the interior surface 26 and the exterior surface 28a. The interior surface 26 faces upward into the interior of the pet cabana, and the exterior surface 28a faces outwardly (downwardly) from the pet cabana when a pet cabana is disposed as shown in FIG. 1.

In the illustrated embodiment, the exterior surface 28a has a non-slip structure 30. The non-slip structure 30 may be provided on the entire surface of the exterior surface 28a, or on one or more portions of the exterior surface 28a.

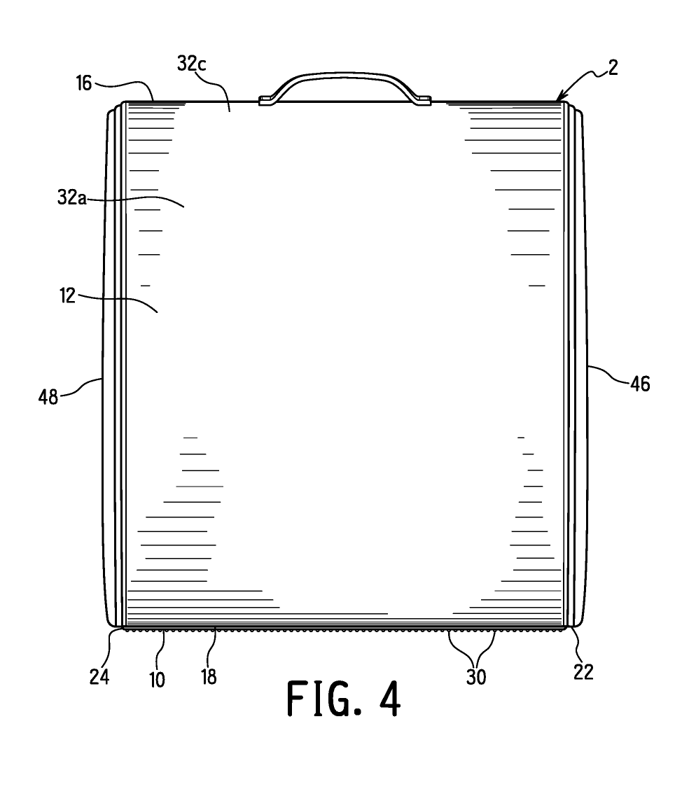

By non-limiting example, the non-slip structure 30 comprises a plurality of rubber nubs arranged to protrude outward (downward in FIGS. 1 and 4) from the exterior surface 28a. The non-slip structure can be made of any suitable material and provided in any suitable arrangement for preventing the pet cabana from sliding on a smooth surface (e.g., a hardwood floor or a countertop) when a pet enters or exits the pet cabana.

As illustrated in FIGS. 1-3, the first wall portion 12 is connected to the base section 10 at the first side 18 of the base section 10. The first wall portion 12 extends upwardly and connects to the roof section 16 above the base section 10. The first wall portion 12 has an exterior surface 32a, and an interior surface 34a. The interior surface 34a is formed by a gathered fabric layer 41 (explained in more detail later).

As illustrated in FIGS. 1-3, the second wall portion 14 is connected to the base section 10 at the second side 20 of the base section 10. The second wall portion 14 extends upwardly and connects to the roof section 16 above the base section 10. The second wall portion 14 has an exterior surface 32b, and an interior surface 34b. The interior surface 34b is formed by the gathered fabric layer 41.

As illustrated in FIGS. 1-3, the roof section 16 is connected to both of the first wall portion 12 and the second wall portion 14 at positions above the base section 10. In the illustrated embodiment, the roof section 16 is integral and continuous with the first wall portion 12 and the second wall portion 14. However, alternatively, the roof section 16 may be a separate structure connecting the first wall portion 12 to the second wall portion 14. The roof section 16 has an exterior surface 32c, and an interior surface 34c. The interior surface 34c is formed by the gathered fabric layer 41.

In the illustrated embodiment, the same gathered fabric layer 41 forms each of the interior surfaces 34a, 34b, and 34c of the first wall portion 12, the second wall portion 14, and the roof section 16, respectively. However, it is also acceptable to provide separate gathered fabric layers on each of the first wall portion 12, the second wall portion 14, and the roof section 16. Alternatively, it is acceptable to provide the gathered fabric layer 41 on only one or two of the first wall portion 12, the second wall portion 14, and the roof section 16.

Additionally, in the illustrated embodiment, each of the first wall portion 12, the second wall portion 14, and the roof section 16 includes several layers that are provided uniformly and continuously across the entirety of the first wall portion 12, the second wall portion 14, and the roof section 16. Specifically, the exterior layer 32, an internal pad 36, a substrate layer 39, and an internal layer 34 (gathered fabric layer 41) are common and continuous in the first wall portion 12, the second wall portion 14, and the roof section 16. However, it is also acceptable the first wall portion 12, the second wall portion 14, and the roof section 16 to have similar or different layers that are provided separately for each of the first wall portion 12, the second wall portion 14, and the roof section 16, respectively.

As can be seen in FIGS. 8 and 9, the first wall portion 12, the second wall portion 14, and the roof section 16 may be formed as a single continuous structure having a uniform cross sectional structure. In the illustrated embodiment, the first wall portion 12, the second wall portion 14, and the roof section 16 are continuously formed as a single inverted U-shaped member. Of course, the invention is not limited to a U-shape. As mentioned above, the U-shaped member may include several layers, such as an exterior layer 32, an interior layer 34, and an internal pad 36. The exterior layer 32 includes the exterior surfaces 32a, 32b, and 32c. The interior layer 34 includes internal surfaces 34a, 34b, and 34c. The internal pad 36 is disposed between the exterior layer 32 and interior layer 34. The exterior layer 32, interior layer 34, and internal pad 36 each extend from the first side 18 of the base section 10 to the second side 20 of the base section 10.

The inverted U-shaped element extends from the base section 10. In the illustrated embodiment, the exterior layer 32 is preferably a rugged nylon material, and the gathered fabric layer 41 forming the interior layer 34 is preferably made of a soft, fuzzy fabric that is pleasant to the touch. It is also acceptable if the exterior layer 32 is made of a rigid material, such as hard plastic. The gathered fabric layer 41 is stitched in a gathered arrangement to create drooping of the gathered material. The internal pad 36 is foam that is preferably between 1-2 cm thick. In the illustrated embodiment, the internal pad is about 1.5 cm thick. The internal pad 36 is more rigid than the exterior layer 32 and the interior layer 34 and helps maintain the shape of the pet cabana.

As shown in FIGS. 1-3, a pair of end members 46 and 48 are disposed at opposite ends of the inverted U-shaped member along the longitudinal direction, with each end member having a cutout 50 and 52 respectively. Preferably, each cutout 50 and 52 has a shape corresponding to an outline of the pet cabana when viewed in the longitudinal direction. The cutouts 50 and 52 serve as openings for a pet to enter and exit the pet cabana. External seams 54 and 56 may be provided between the tubular member 2 and the end members 46 and 48, respectively. The external seams 54 and 56 can optionally be covered with nylon strips that are stitched to the seams 54 and 56. It is also acceptable if one of the end members 46 and 48 is not provided with a cut out such that the pet cabana has only one opening that allows a pet to enter and exit.

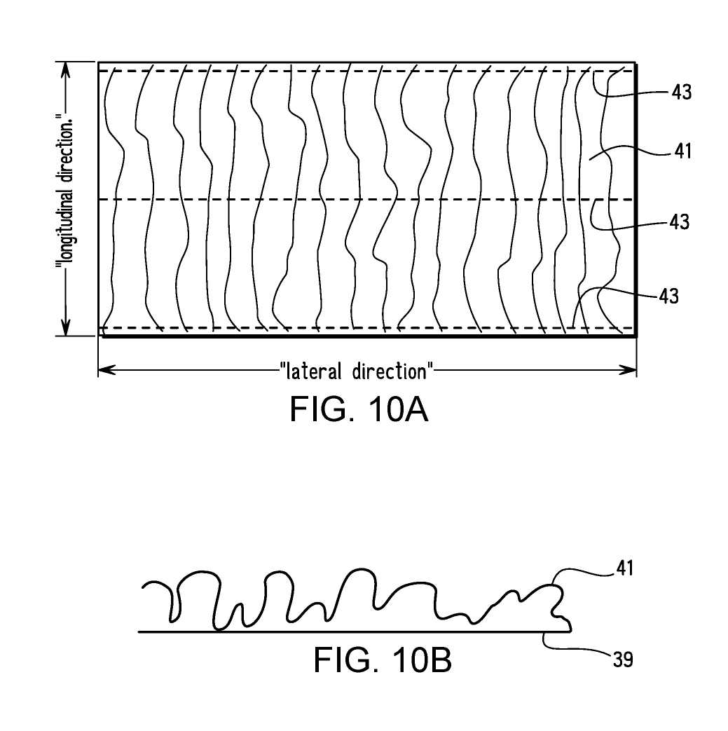

While referring to FIGS. 10A-10B, the arrangement of the interior layer 34 will now be described in further detail. The interior layer 34 basically includes a substrate layer 39 and a gathered fabric layer 41. The substrate layer 39 is a layer of substantially flat ungathered fabric, and the gathered fabric layer 41 is a layer of undulating fabric attached to the substrate layer 39. The gathered fabric layer 41 is attached to the substrate layer 39 at stitched seams (attachment portions) 43. The gathered fabric layer 41 is spaced apart from the substrate layer 39 between the stitched seams 43. Thus, the gathered fabric layer 41 lines the first wall portion 12, the second wall portion 14, and the roof section 16 such that the gathered fabric layer 41 freely hangs from the substrate at freely hanging portions 45 between the plurality of attached portions.

In the illustrated embodiment, as shown in FIG. 10A, there are three stitched seams 43 attaching the gathered fabric layer 41 to the substrate layer 39. The stitched seams 43 correspond to the attachment portions recited in the claims. The three stitched seams 43 are arranged extending substantially parallel to one another. A plurality of pleats 41a are formed in the gathered fabric layer 41 along the stitched seams 43. The gathered fabric layer 41 is arranged such that the freely hanging portions 45 are formed as a plurality of undulations which extend skew to the plurality of stitched seams 43. Any arrangement of stitched seams 43 or another type of attachment portion is acceptable so long as a plurality of loose, freely hanging portions 45 are formed in the gathered fabric layer 41. However, the invention is not limited to a stitched seam and any suitable method of attaching the gathered fabric layer to the substrate layer 39 may be used.

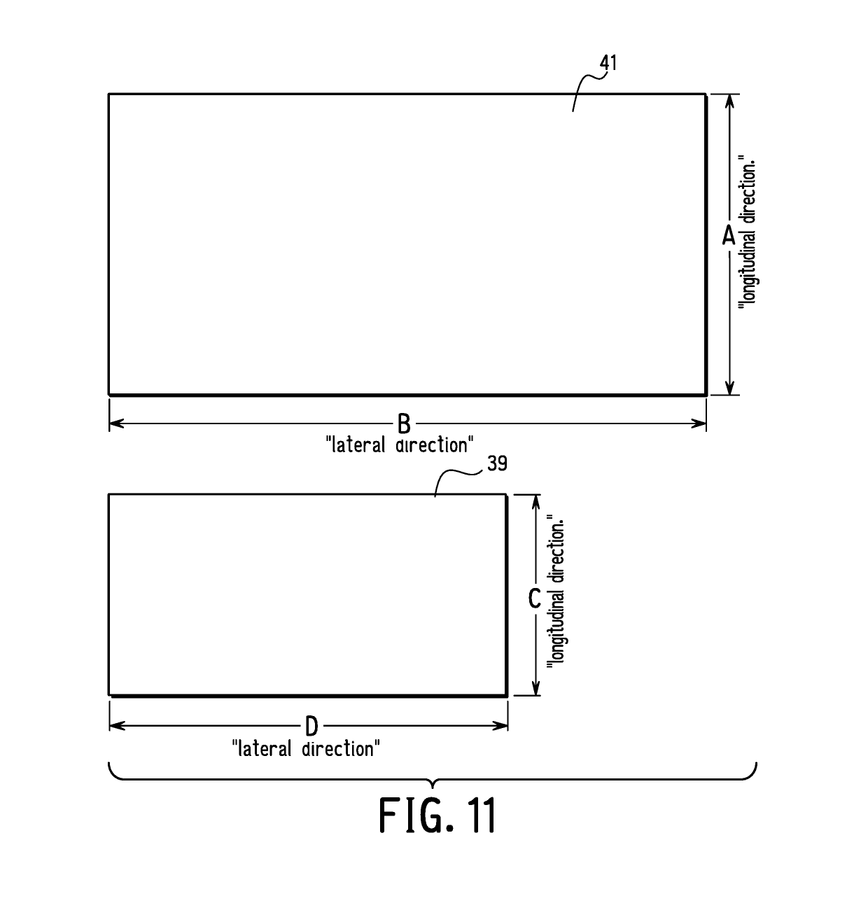

Assuming the gathered fabric layer 41 is provided on the entire substrate layer 39 as in the illustrated embodiment, the substrate layer 39 will have a surface area that is smaller than a surface area of the gathered fabric layer 41. In other words, since the gathered fabric layer 41 covers the substrate layer 39 and includes the freely hanging portions 45, the total surface area of the material forming the gathered fabric layer 41 is larger than the total surface are of the material forming the substrate layer 39. For the purposes of this disclosure, as shown in FIG. 11, the surface area of the substrate layer 39 is calculated by multiplying a width C and a length D of the piece of material used to make the substrate layer 39. Similarly the surface area of the gathered fabric layer 41 is calculated by multiplying a width A and a length B of the piece of material used to make the gathered fabric layer 41 in an ungathered (substantially flat) state.

In the illustrated embodiment, the substrate layer 39 is roughly the same size and shape as the interior surface of the internal pad 36. On the other hand, the material forming the gathered fabric layer 41 is longer and wider than the material forming the substrate layer 39. In the illustrated embodiment, the widthwise direction of the substrate layer 39 and the gathered fabric layer 41 (corresponding to the widths C and A, respectively) are arranged in a longitudinal direction of the pet cabana, i.e., a direction along the passageway of the pet cabana. Meanwhile, the lengthwise direction of the substrate layer 39 and the gathered fabric layer 41 (corresponding to the lengths D and B, respectively) are arranged along a lateral direction (along the U-shape) of the inverted U-shaped member. In the illustrated embodiment, the ungathered length B of the gathered fabric layer 41 along the lateral direction is only moderately longer than the lateral length D of the internal pad 36 and the substrate layer 39 (e.g., 10-20%). However, the ungathered width A of the gathered fabric layer 41 along the longitudinal direction is significantly longer than the longitudinal width C of the internal pad 36 and the substrate layer 39 (e.g., 125-200%). More specifically, in this embodiment, the width A of the gathered fabric layer 41 along the longitudinal direction is about 150% of the longitudinal length of the internal pad 36 and the substrate layer 39. However, it will be understood from this disclosure that different amounts and distributions of drooping can be obtained by adjusting the size of the ungathered material used to make the gathered fabric layer 41 with respect to the size of the material used to make the substrate layer 39, and by adjusting the location and number of stitched seams 43 or other attachment portions. Thus, the size of the material used to make the gathered fabric layer 41 may selected as appropriate in order to achieve a desired droop distance DD in view of the number and arrangement of stitched seams 43. The droop distance DD is explained in more detail below in conjunction with explaining a second embodiment.

A second embodiment will now be explained with reference to FIG. 9. In the second embodiment, the width A of the material used to make the gathered fabric layer 41 is the same as the first embodiment, but the length B is larger to create a larger droop distance DD′ than the droop distance DD of the first embodiment. Also, in the second embodiment, similarly to the first embodiment, the gathered fabric layer 41 is stitched along three lateral seams 43, one stitched seam 43 at each end and one central seam 43. As in the first embodiment, the seams 43 extend in the lateral direction of the pet cabana from the first side 18 to an apex of the roof 16, and from the roof 16 to the second side 20. In addition, the gathered fabric layer 41 is stitched along opposite sides of the base section 10 where the base section 10 is joined to the first and second wall portions 12 and 14.

In the illustrated embodiments, a handle H is provided on the exterior layer 32 at the apex of the roof section 16. The gathered fabric layer may 41 may be attached at points along the interior of the roof section 16 that do not correspond to where the handle H is disposed, or, alternatively, the handle H may be attached to the exterior of the roof section 16 at the same points as where the gathered fabric layer 41 is attached to the interior of the roof section 16. In other words, the positions of the stitched seams 43 are not limited by the position of the handle H. On the other hand, the structure used to attach the handle H to the roof section 16 may also be configured to secure the gathered fabric layer 41 to the roof section 16 separately from the stitched seams 43. For example, stitches used to secure the handle H may be arranged to penetrate the roof section 16 and the gathered fabric layer 41 such that the gathered fabric layer 41 is secured to the roof section 16 by the stitches.

As shown in FIGS. 8 and 9, in each of the first and second embodiments, the gathered fabric layer 41 has a droop distance DD or DD′ from the internal surface of the substrate layer 39 to the gathered fabric layer 41 reaches about 5-20 times the thickness T of the internal pad 36. More specifically, in the first embodiment, the droop distance DD from the internal surface of the internal pad 36 to the gathered fabric layer 41 reaches about 7-12 times the thickness T of the internal pad 36. Preferably, the droop distance DD generally averages about 10 times the thickness T of the internal pad 36. In the second embodiment, the droop distance DD′ from the internal surface of the substrate layer 39 to the gathered fabric layer 41 reaches about 12-18 times the thickness T of the internal pad 36. Preferably, the droop distance DD′ of the second embodiment averages about 15 times the thickness T of the internal pad 36. The droop distance DD or DD′ will vary according to the proximity of the position where the droop distance DD or DD′ is measured to a stitched steam 43. Of course, the droop distance DD or DD′ at attachment portions, such as at the base section 10, will be zero. The ranges of droop distances DD and DD′ mentioned above are measured at intermediate positions between stitched seams 43 where the droop distance DD and DD′ are approximately largest.

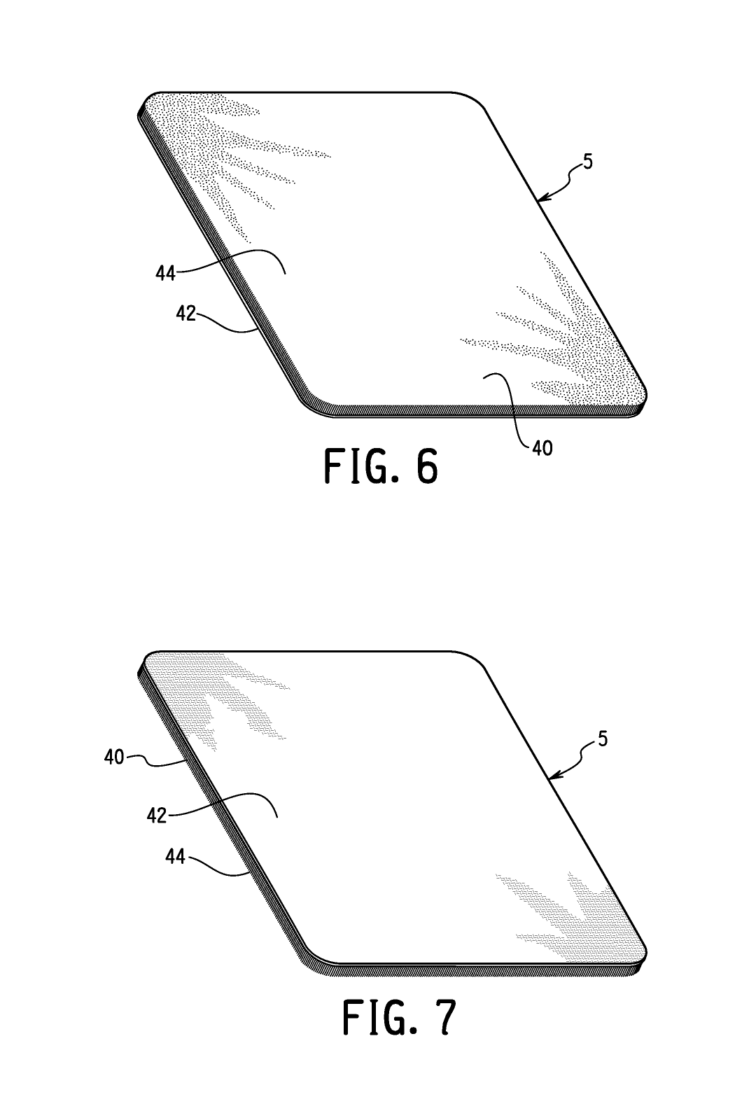

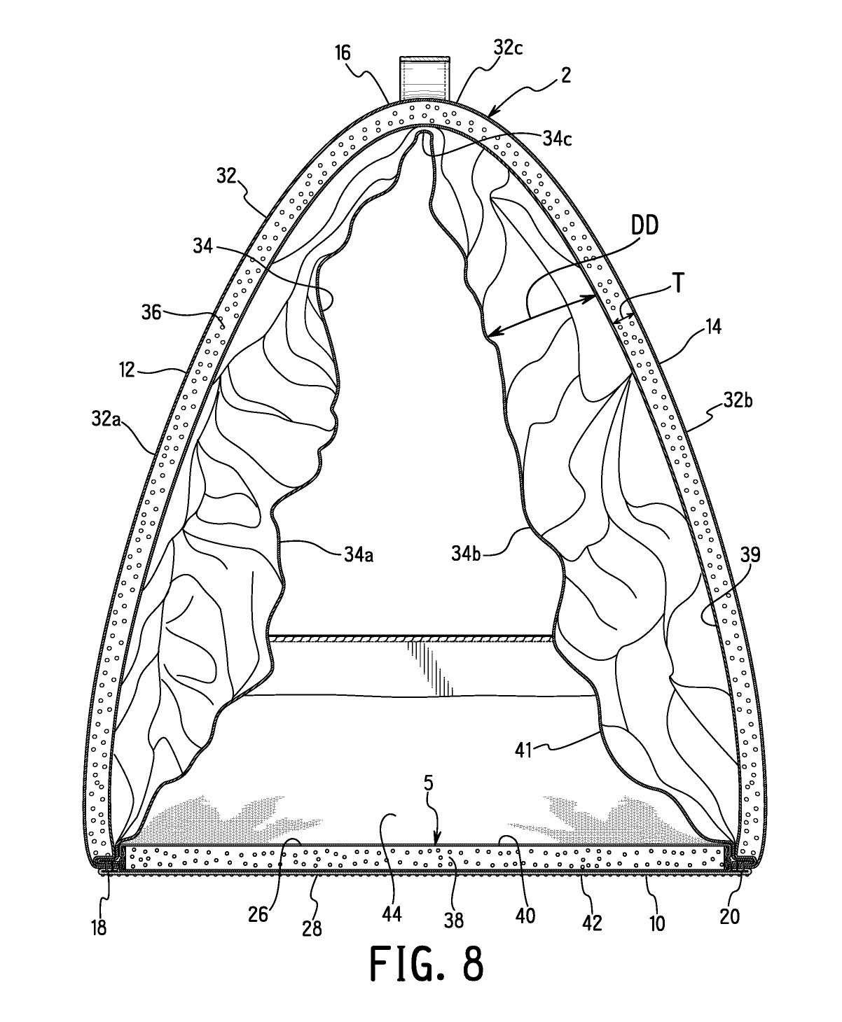

The removable pad 5, as shown in FIGS. 6 and 7, fits inside the tubular member 2. The pad has an internal pad 38 and a fabric covering 40. In the illustrated embodiment, a first side 42 of the covering is nylon, while an opposing second side 44 is plush. The internal pad 38 is foam that is preferably between 1-2 cm thick. In the illustrated embodiment, the internal pad 38 is about 1.5 cm thick. The first side 42 of the pad faces down when positioned within the tubular member 2 so the pet has a plush surface to walk, roll and/or lie on. While nylon and a plush material are preferable, any suitable material used for pet beds and/or cabanas could be used. The removable pad 5 together with the external layer 28 form the base section 10 of the tubular member.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet cabana comprising:
a base section including at least one layer made of a first material, the base section forming a bottom portion of the pet cabana;
a wall section including at least one layer made of a second material, the wall section being attached to at least a portion of a periphery of the base section such that the wall section extends upward from the base section when the base section rests on a horizontal surface;
a roof section including at least one layer made of a third material, the roof section being attached to an upper periphery of the wall section such that the roof section is disposed above the base section when the base section rests on the horizontal surface; and
a gathered material layer including at least one layer made of a fourth material, the gathered material layer being attached to at least a portion of an interior surface of at least one of the wall section and the roof section, the fourth material being pliable and attached liberally such that at least one freely hanging portion of the gathered material layer droops from the interior surface within an interior space defined by the base section, the wall section, and the roof section.

2. The pet cabana according to claim 1, wherein
the gathered material layer is attached to the interior surface with at least one stitched seam.

3. The pet cabana according to claim 2, wherein
a plurality of pleats are formed in the gathered material layer along the stitched seam.

4. The pet cabana according to claim 1, wherein
the gathered material layer is attached to the interior surface at a plurality of attachment portions to form a plurality of the freely hanging portions.

5. The pet cabana according to claim 4, wherein
the attachment portions are arranged such that the freely hanging portions have an undulated shape between the attachment portions.

6. The pet cabana according to claim 4, wherein
the attachment portions are formed by a plurality of stitched seams that secure the gathered material layer to the interior surface.

7. The pet cabana according to claim 6, wherein
the stitched seams are parallel to one another.

8. The pet cabana according to claim 1, wherein
the wall section is attached to the entire periphery of the base section;
the wall section includes at least one opening for the pet to enter the interior space.

9. The pet cabana according to claim 8, wherein
the wall section includes at least one end portion provided as a separate member from a remainder of the wall section, the at least one opening being provided in the at least one end portion.

10. The pet cabana according to claim 1, wherein
the interior surface is of the wall section and the roof section, and the gathered material layer is attached to the interior surface of the wall section and the roof section.

11. The pet cabana according to claim 1, wherein
the base section includes a removable pad configured to be placed the at least one layer made of the third material inside the interior space, the removable pad including at least one layer of an ungathered plush material and a gathered material on at least one side.

12. The pet cabana according to claim 1, wherein
at least one of the first material, the second material, the third material, and the fourth material is a fabric material.

13. The pet cabana according to claim 1, wherein
the at least one of the wall section and the roof section includes a substrate layer made of a fifth material, the substrate layer forming an innermost layer of the at least one of the wall section and the roof section, the gathered material layer being attached to the substrate layer.

14. The pet cabana according to claim 13, wherein
the fifth material is a fabric material, and the substrate layer is arranged flat and ungathered.

15. The pet cabana according to claim 13, wherein
the at least one of the wall section and the roof section includes an internal pad disposed between the substrate layer and at least one of the second material and the third material, respectively, the internal pad being thicker than the substrate material and the at least one of the second material and the third material.

16. The pet cabana according to claim 15, wherein
the roof section and at least a portion of the wall section have a continuous structure with a uniform cross section wherein the second material and the third material are continuous and made of an identical material, the internal pad is a single pad shared by the wall section and the roof section, and the substrate layer is continuously provided with respect to the wall section and the roof section.

17. The pet cabana according to claim 16, wherein
the second material and the third material are made of nylon fabric and form external surfaces of the pet cabana.

18. The pet cabana according to claim 1, wherein
an exterior surface of the base section includes a non-slip structure.

19. The pet cabana according to claim 1, wherein
a handle is attached to an exterior surface of the roof section.
